(19) United States
(12) Patent Application Publication
(10) Pub. No.: US 2015/0141104 A1
(43) Pub. Date: May 21, 2015

(54) Block Puzzle Game Machine

(71) Applicant: Paul Lapstun, Rodd Point (AU)

(72) Inventor: Paul Lapstun, Rodd Point (AU)

(21) Appl. No.: 14/609,450

(22) Filed: Jan. 30, 2015

Related U.S. Application Data
(63) Continuation of application No. 13/621,105, filed on Sep. 15, 2012, now abandoned.

(51) Int. Cl. A63F 9/06; A63F 13/52; A63F 13/42

(52) U.S. Cl. CPC A63F 9/0612; A63F 13/42; A63F 13/52
USPC 463/9

(57) ABSTRACT

A block puzzle game machine comprising at least one processor, at least one memory containing a program, at least one display, and at least one input mechanism; the program comprising instructions executable by the at least one processor that implement a block puzzle game, the game comprising a virtual block puzzle, the block puzzle comprising an array of substantially cubic puzzle blocks, one face of each puzzle block bearing a face pattern that is a fragment of a solution pattern, the face patterns of the puzzle blocks together forming the solution pattern when the puzzle is in a solved state, the puzzle manipulable via a constrained set of moves to transform it from any one of a set of scrambled states to the solved state, the constrained set of moves comprising any move that rotates one row of puzzle blocks in the array ninety degrees about a longitudinal axis of the row, and any move that rotates one column of puzzle blocks in the array ninety degrees about a longitudinal axis of the column, the game configured to display a representation of the puzzle on the at least one display, accept user input via the at least one input mechanism, identify, from the user input, one move from the constrained set of moves, transform the puzzle in accordance with the identified move, and display the transformed puzzle on the at least one display.

### FIELD OF THE INVENTION

The present invention relates to sequential move puzzles and game machines for such puzzles.

### BACKGROUND OF THE INVENTION

A sequential move puzzle is a puzzle that is solved via a sequence of moves, where the effect of each move is dependent on the state of the puzzle after the previous move. The order in which the moves are applied is therefore significant. The pieces of the puzzle can typically be arranged in a large number of ways, and the set of allowed moves is constrained. This makes solving the puzzle a challenge.

So-called twisty puzzles such as Rubik's Cube and its variants [Nichols72, Rubik83] represent a well-known class of sequential move puzzles. Sliding puzzles, such as the well-known Fifteen Puzzle, represent another class.

Sequential move puzzles can be both entertaining and educational, but many such puzzles have the disadvantage that they are too difficult for casual puzzlers to solve. Many puzzlers only solve them after being taught how.

Of interest, therefore, is any sequential move puzzle that is challenging enough to be entertaining, but sufficiently easy that a casual puzzler can eventually solve it without help.

Sequential move puzzles that allow the rotation of smaller groups of pieces than typical twisty puzzles are generally easier to solve. For example, puzzles exist that allow two-dimensional arrays of multi-colored balls mounted in a frame and coupled via gears to be rotated in row-wise and column-wise groups [Seidman85, Rom05]. However, these puzzles are awkward to manipulate and do not allow particularly aesthetic patterning due to their widely-spaced pieces.

### SUMMARY OF THE INVENTION

In a first aspect, the present invention provides a block puzzle comprising an array of substantially cubic puzzle blocks, wherein one face of each puzzle block bears a face pattern that is a fragment of a solution pattern, the face patterns of the puzzle blocks together forming the solution pattern when the puzzle is in a solved state, the puzzle manipulable via a constrained set of moves to transform it from any one of a set of scrambled states to the solved state, the constrained set of moves comprising any move that rotates one row of puzzle blocks in the array ninety degrees about a longitudinal axis of the row, and any move that rotates one column of puzzle blocks in the array ninety degrees about a longitudinal axis of the column.

During a move, a group of puzzle blocks being rotated may be held together via a first and a second externally-applied substantially linear force, the linear forces having substantially equal magnitudes but substantially opposite directions, the directions substantially parallel to a longitudinal axis of the group, the first linear force acting on a first end face of a first puzzle block at a first longitudinal end of the group, the second linear force acting on a second end face of a second puzzle block at a second longitudinal end of the group; and the group may be rotated via a first and a second externally-applied momentary substantially rotational force, the first rotational force acting on the first end face, the second rotational force acting on the second end face.

The linear forces may be applied by pressing on each of the end faces with one or more fingers, and the rotational forces may be applied by pressing on each of the end faces with two or more fingers and moving the fingers relative to each other.

Each puzzle block may have at least one anti-slip surface feature to reduce inter-block slippage when two or more puzzle blocks are lifted in a group, the anti-slip surface feature selected from the group comprising: a textured surface finish, a high-friction surface finish, an elastomeric surface finish, a convex surface feature that mates with a concave surface feature on another block, and a concave surface feature that mates with a convex surface feature on another block.

Each puzzle block may be constructed from any suitable material, or mixture of materials, including wood, polymer, ceramic, glass, metal, and textile; and the patterned faces of the puzzle block may be rendered in any suitable way, including via a surface finish such as painting or dyeing, via an inlayed material, via sunken relief, via surface texture, or via a combination of these.

In a second aspect, the present invention provides a block puzzle game machine comprising:

(i) at least one processor,
(ii) at least one memory,
(iii) at least one display, and
(iv) at least one input mechanism,
the memory storing instructions executable by the at least one processor that implement a block puzzle game, the game comprising a virtual block puzzle, the block puzzle comprising an array of substantially cubic puzzle blocks, one face of each puzzle block bearing a face pattern that is a fragment of a solution pattern, the face patterns of the puzzle blocks together forming the solution pattern when the puzzle is in a solved state, the puzzle manipulable via a constrained set of moves to transform it from any one of a set of scrambled states to the solved state, the constrained set of moves comprising any move that rotates one row of puzzle blocks in the array ninety degrees about a longitudinal axis of the row, and any move that rotates one column of puzzle blocks in the array ninety degrees about a longitudinal axis of the column, the game configured to:
(a) display a representation of the puzzle on the at least one display,
(b) accept user input via the at least one input mechanism,
(c) identify, from the user input, one move from the constrained set of moves,
(d) transform the puzzle in accordance with the identified move, and
(e) display the transformed puzzle on the at least one display.

The at least one input mechanism may be selected from the group comprising: a touch interface, a digitizing interface, a button, a joystick, a mouse, a keyboard, gaze tracking, gesture recognition, and voice command recognition.

In a third aspect, the present invention provides method for restoring a block puzzle from any one of a set of scrambled states to a solved state, the block puzzle comprising an array of substantially cubic puzzle blocks, one face of each puzzle block bearing a face pattern that is a fragment of a solution pattern, the face patterns of the puzzle blocks together forming the solution pattern when the puzzle is in the solved state, the puzzle manipulable via a constrained set of moves to transform it from any one of the set of scrambled states to the solved state, the constrained set of moves comprising any move that rotates one row of puzzle blocks in the array ninety degrees about a longitudinal axis of the row, and any move that rotates one column of puzzle blocks in the array ninety degrees about a longitudinal axis of the column, the method comprising:

(a) providing the block puzzle in any one of the set of scrambled states,
(b) selecting a move from the constrained set of moves,
(c) transforming the block puzzle in accordance with the selected move, and
(c) repeating steps (b) and (c) until the block puzzle is in the solved state.

In each aspect of the present invention, the puzzle blocks may be identical; each face of the identical puzzle block may bear a different face pattern; the solution pattern fragments may be identical, and each solution pattern fragment may have a different orientation in the solution pattern; each solution pattern fragment may be different; each solution pattern fragment may be rotationally asymmetric; each face of each puzzle block may bear a different face pattern, and the block puzzle may have multiple solved states, each solved state having a different solution pattern formed from a different set of the face patterns of the puzzle blocks; and the solution pattern may represent a picture selected from the group comprising: an abstract pattern, a drawing, a painting, an artwork, a photograph, and a computer rendering.

### DRAWINGS

### Figures

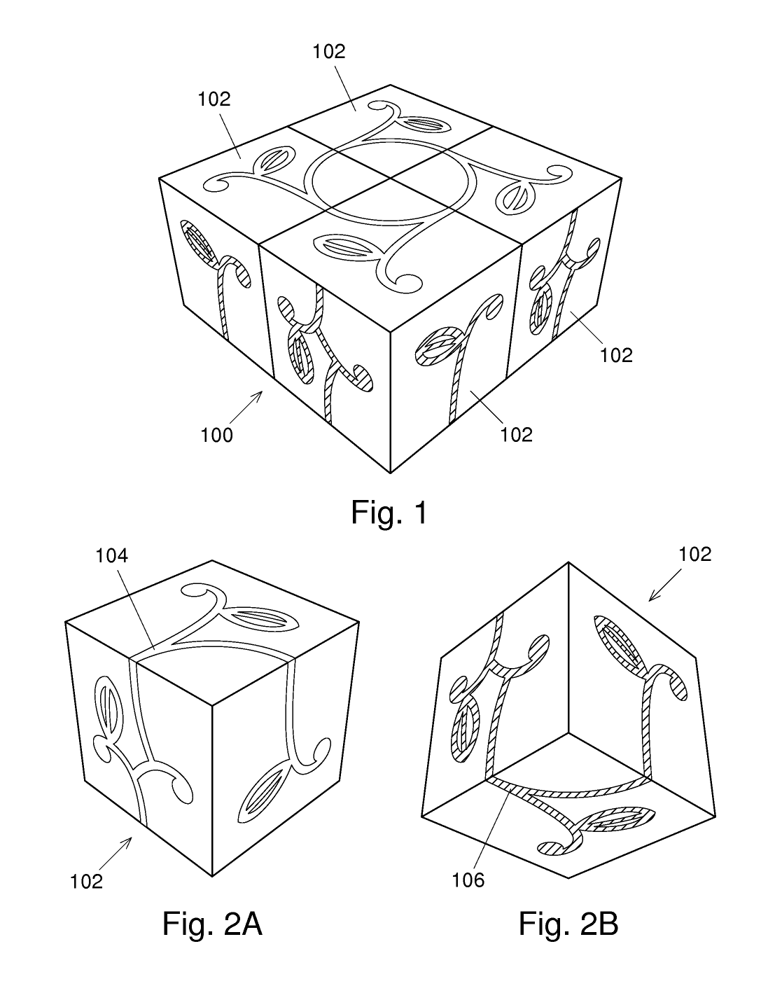

FIG. 1 shows a perspective view of a 2×2 block puzzle.

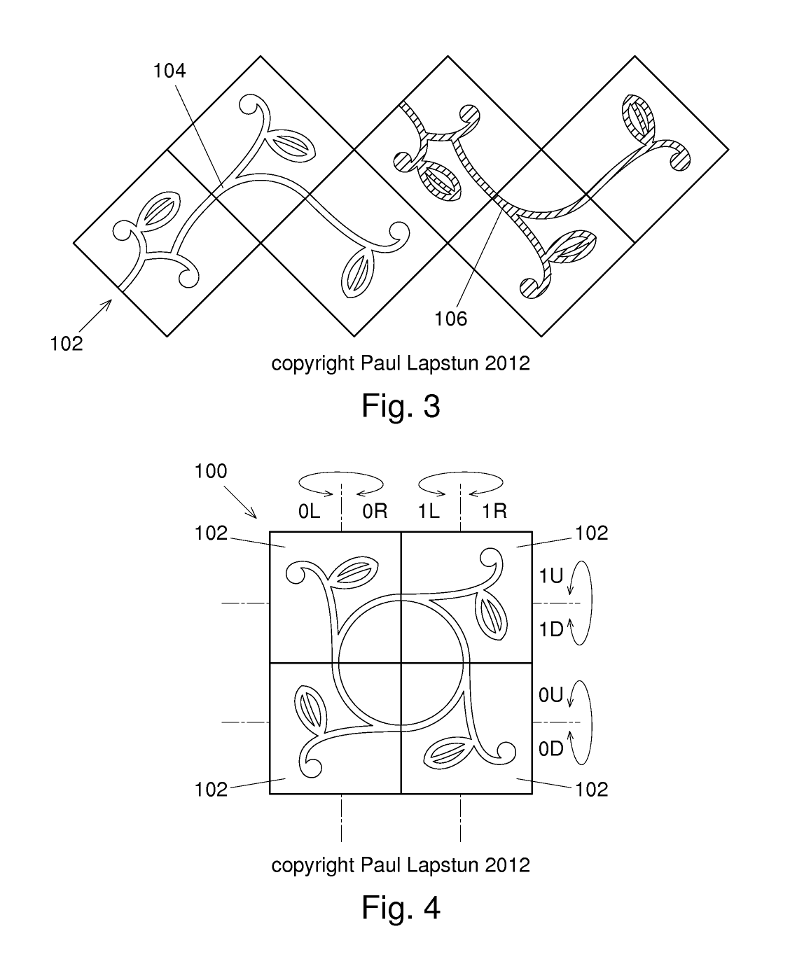

FIG. 2A shows a perspective view of the top and front of one puzzle block of the puzzle.

FIG. 2B shows a perspective view of the bottom and back of the puzzle block.

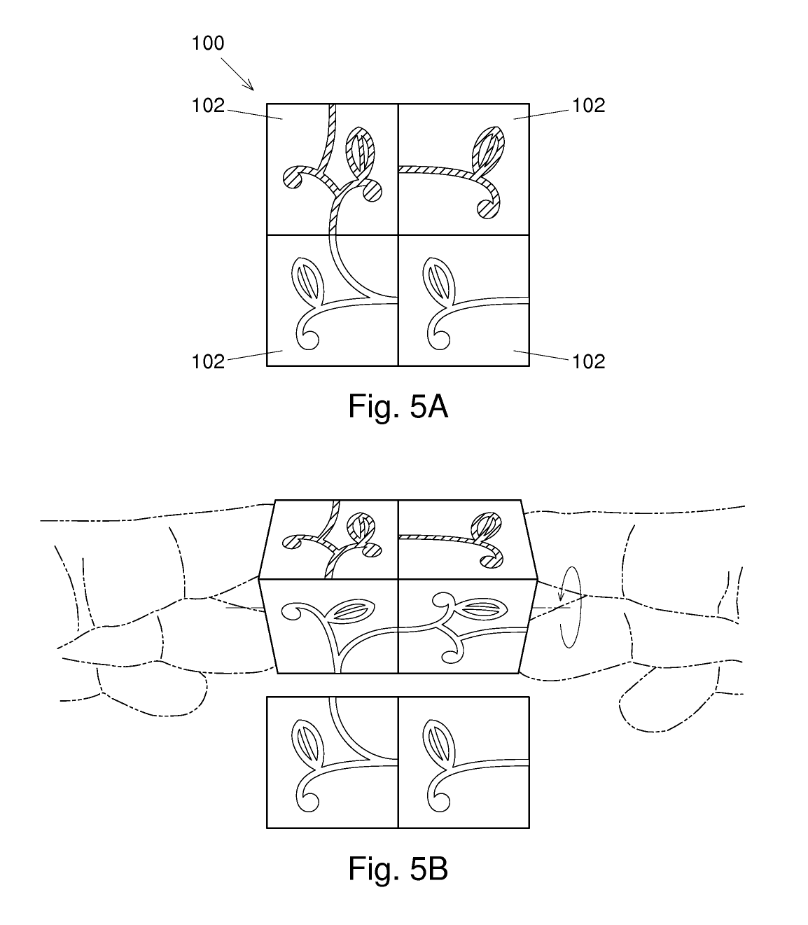

FIG. 3 shows the surface of the puzzle block unfolded.

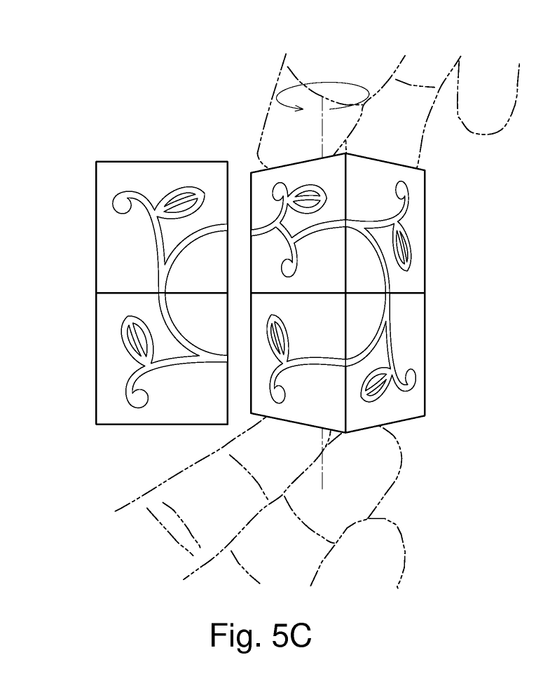

FIG. 4 shows a plan view of the 2×2 block puzzle in its solved state.

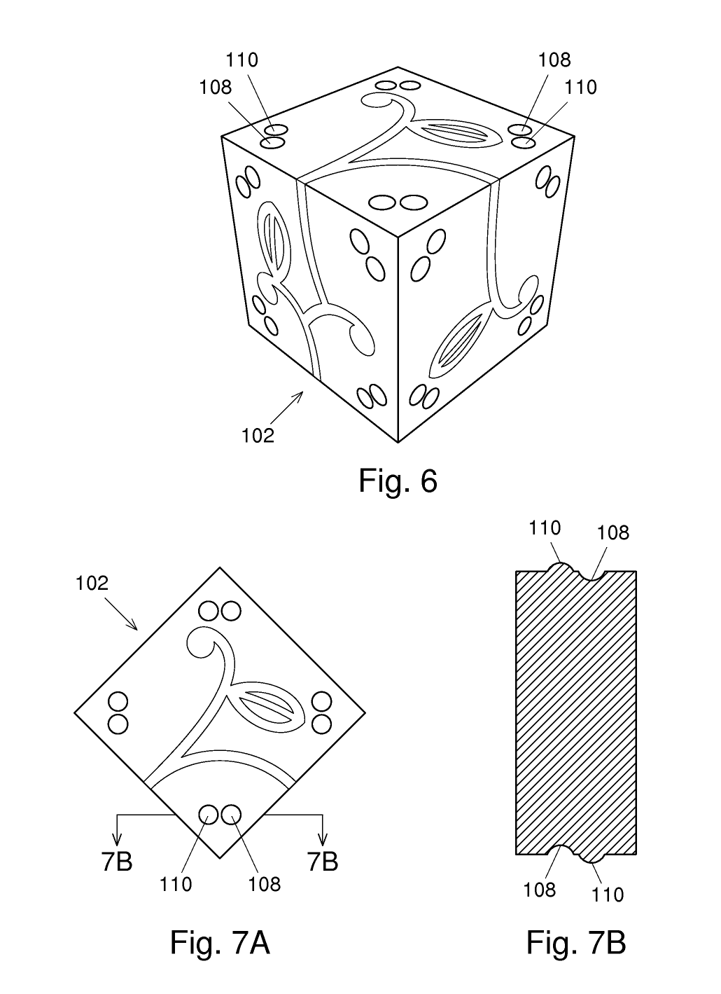

FIG. 5A shows a plan view of the 2×2 block puzzle after being scrambled.

FIG. 5B shows a top perspective view of the 2×2 block puzzle during a row rotation move.

FIG. 5C shows a top perspective view of the 2×2 block puzzle during a column rotation move.

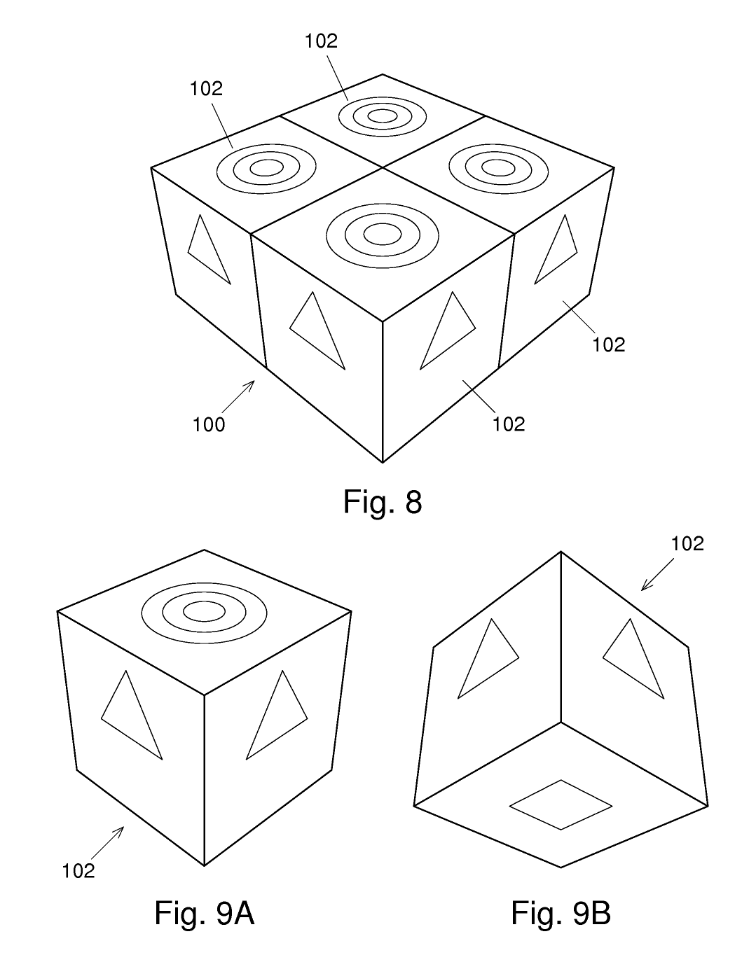

FIG. 6 shows a perspective view of the puzzle block with interlock features.

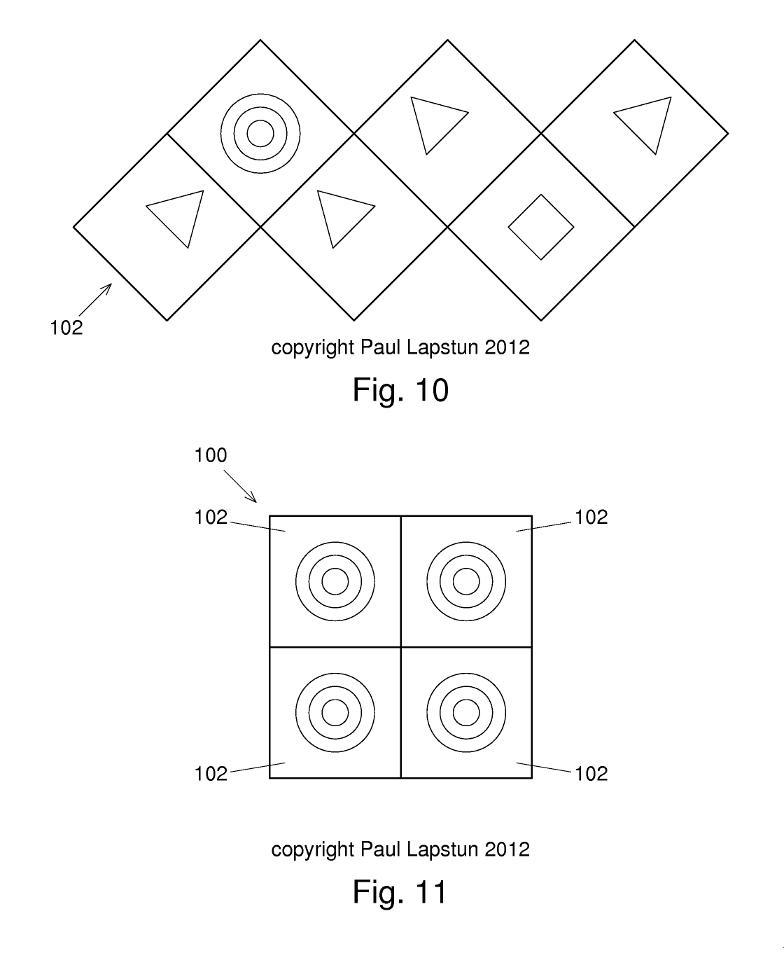

FIG. 7A shows a plan view of the puzzle block with interlock features.

FIG. 7B shows a cross-section of the puzzle block with interlock features.

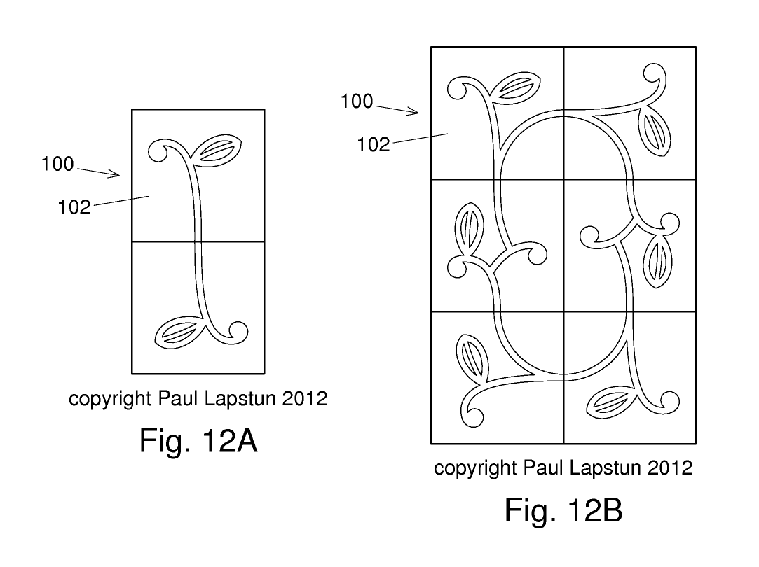

FIG. 8 shows a perspective view of an easier 2×2 block puzzle.

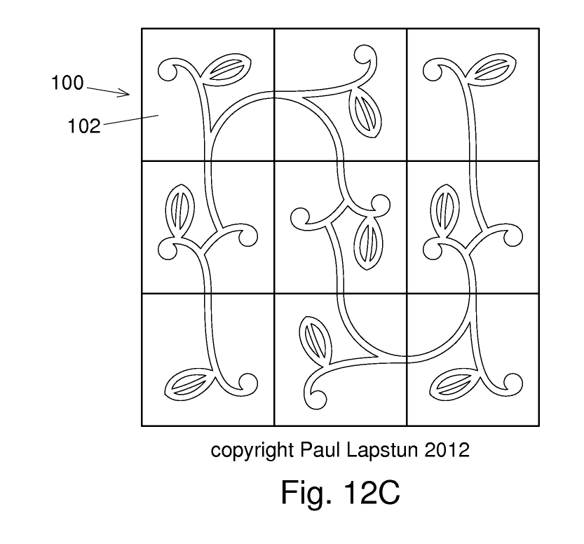

FIG. 9A shows a perspective view of the top and front of one puzzle block of the easier puzzle.

FIG. 9B shows a perspective view of the bottom and back of the puzzle block of the easier puzzle.

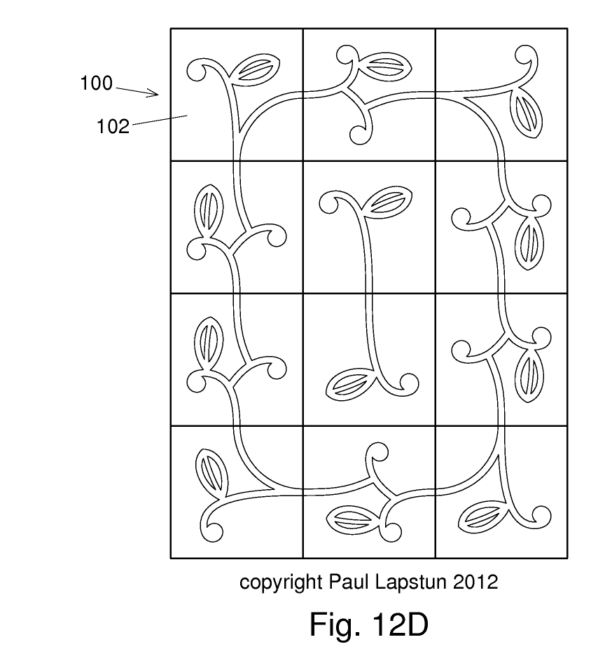

FIG. 10 shows the surface of the easier puzzle block unfolded.

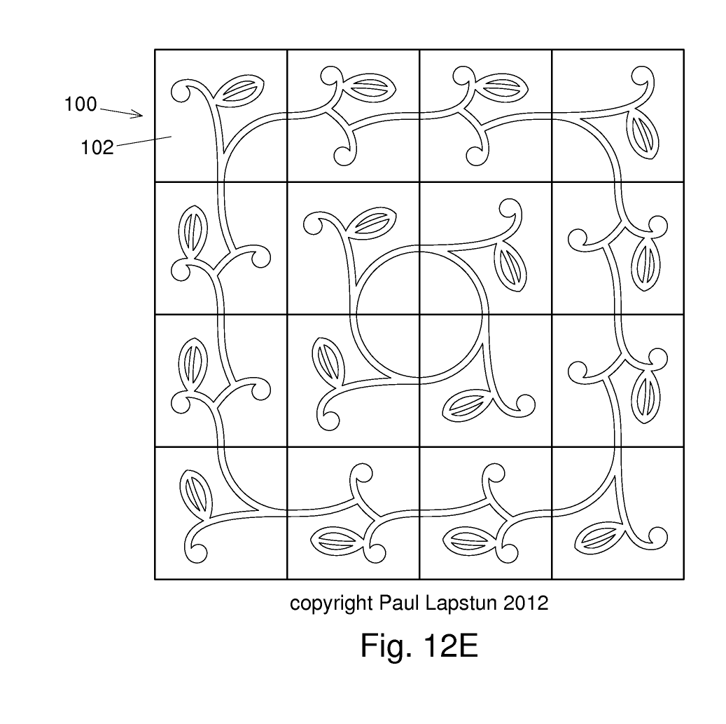

FIG. 11 shows a plan view of the easier 2×2 block puzzle in its solved state.

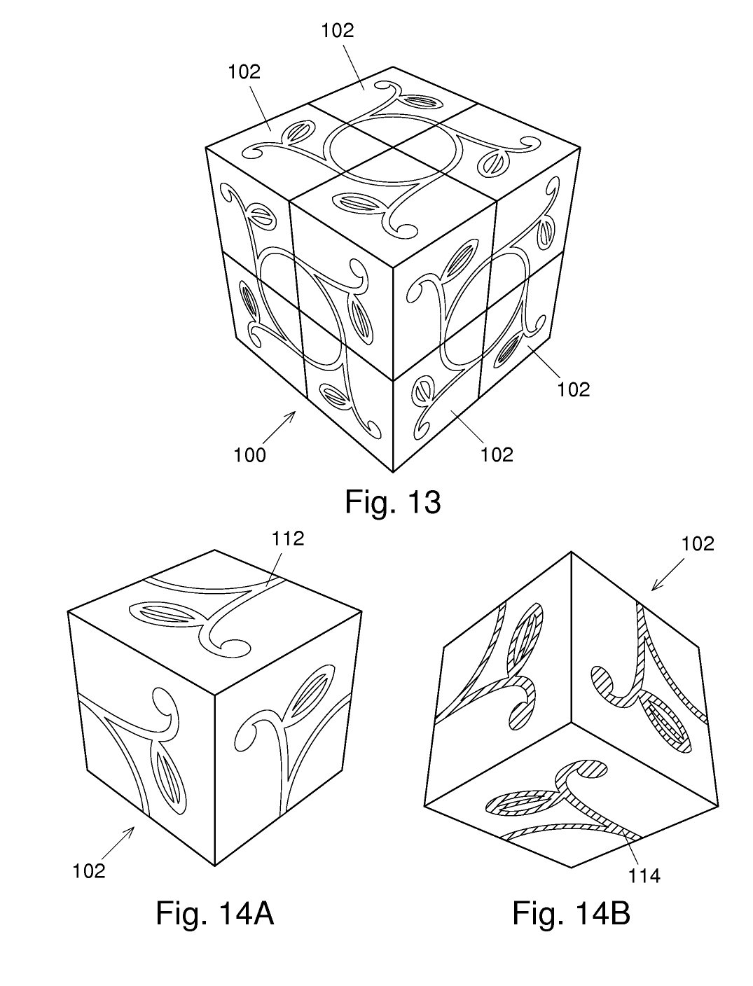

FIG. 12A shows a plan view of a 2×1 puzzle.

FIG. 12B shows a plan view of a 3×2 puzzle.

FIG. 12C shows a plan view of a 3×3 block puzzle.

FIG. 12D shows a plan view of a 4×3 block puzzle.

FIG. 12E shows a plan view of a 4×4 block puzzle.

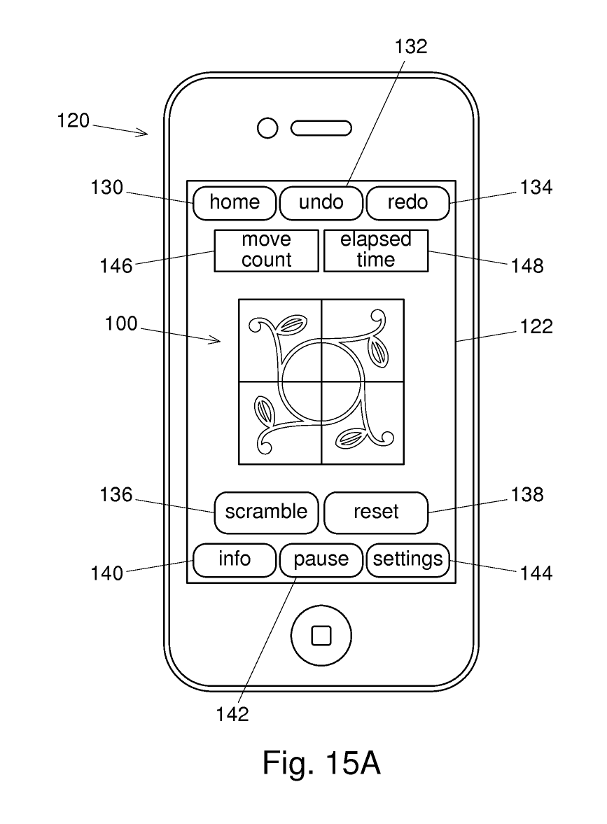

FIG. 13 shows a perspective view of a 2×2×2 multi-layer block puzzle.

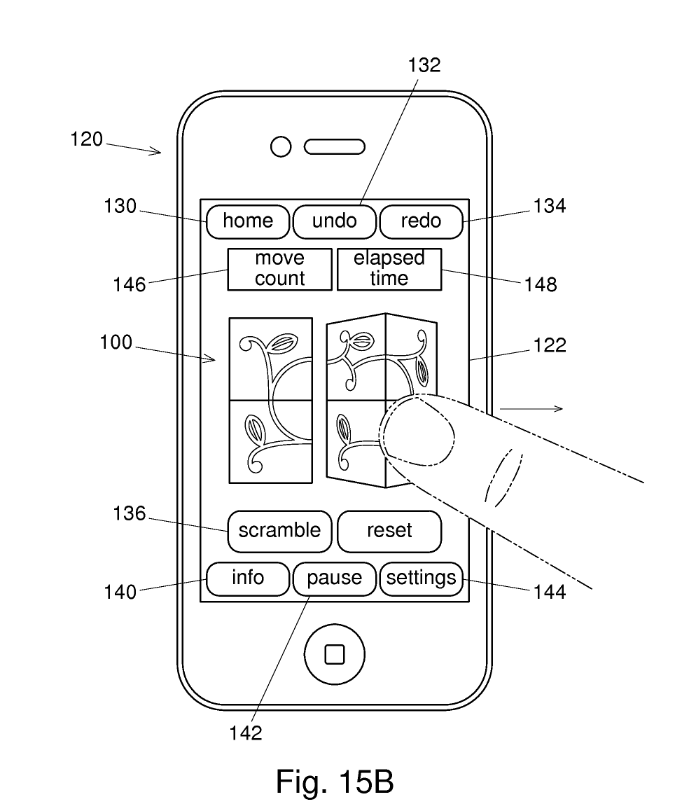

FIG. 14A shows a perspective view of the top and front of one puzzle block of the multi-layer puzzle.

FIG. 14B shows a perspective view of the bottom and back of the puzzle block of the multi-layer puzzle.

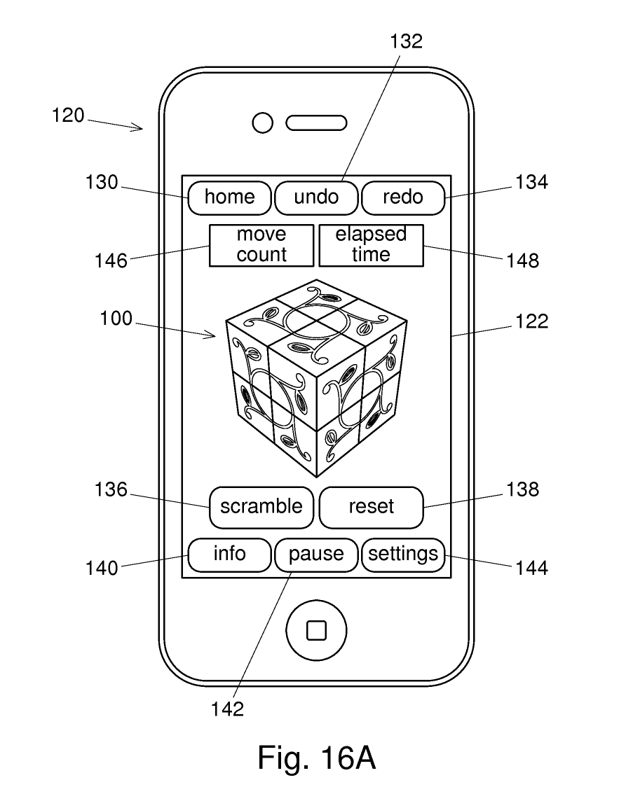

FIG. 15A shows a touchscreen block puzzle game machine.

FIG. 15B shows the touchscreen block puzzle game machine during a move.

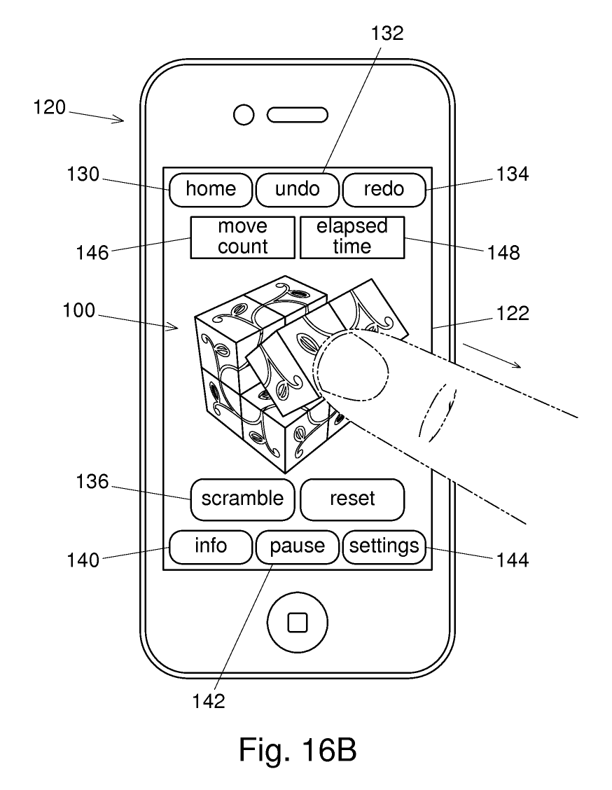

FIG. 16A shows the touchscreen block puzzle game machine with a multi-layer puzzle.

FIG. 16B shows the touchscreen block puzzle game machine with a multi-layer puzzle during a move.

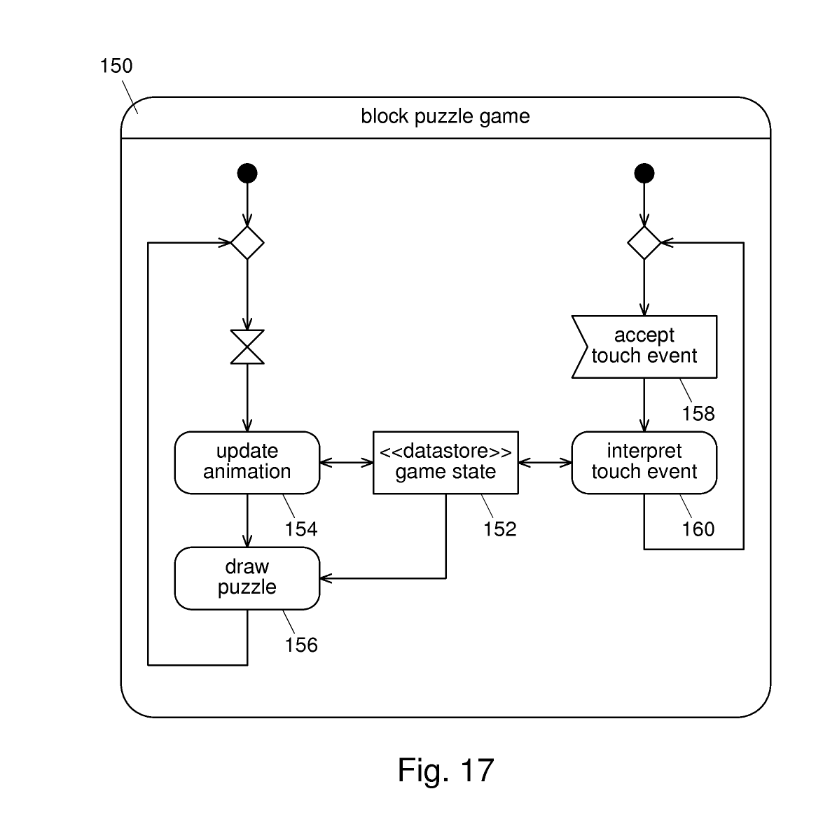

FIG. 17 shows an activity diagram for the block puzzle game.

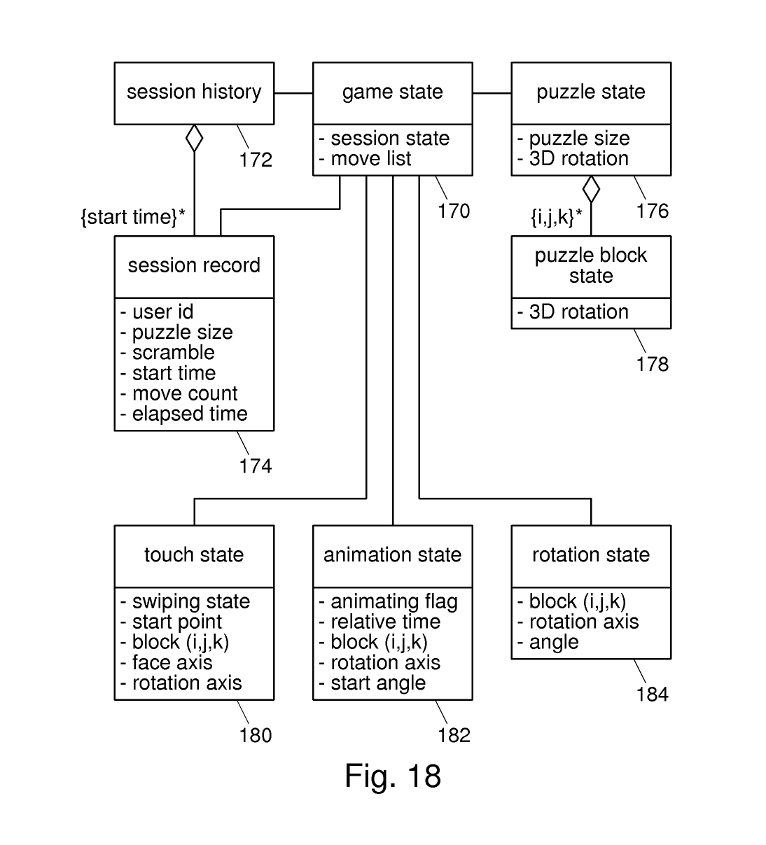

FIG. 18 shows a class diagram for the game state of the block puzzle game.

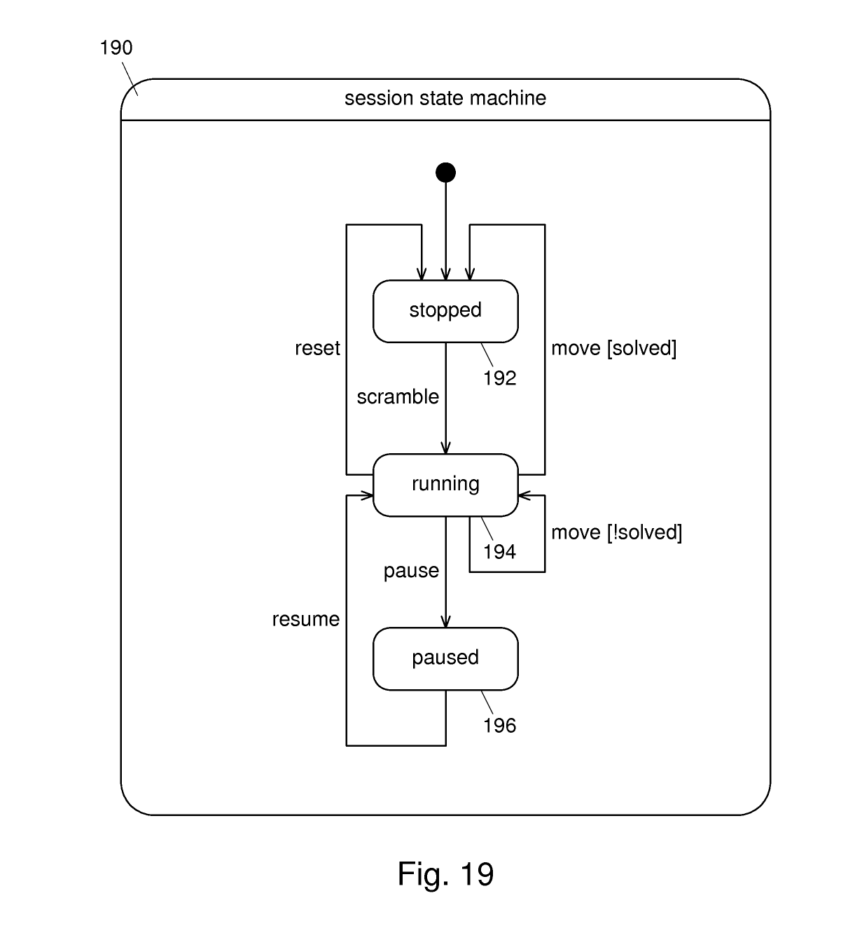

FIG. 19 shows a session state machine for the block puzzle game.

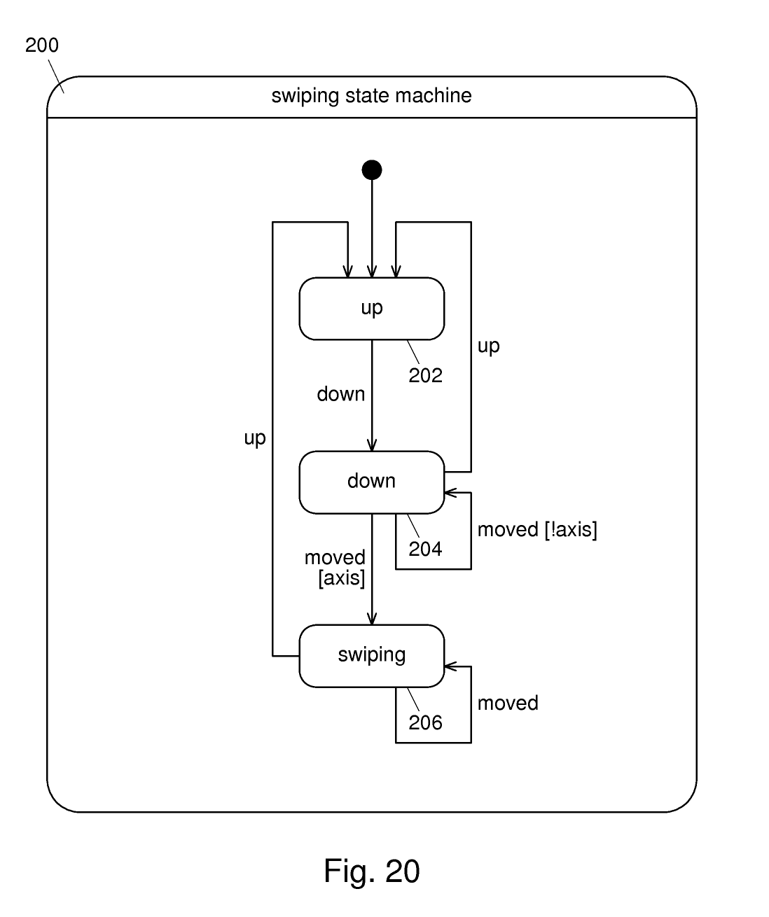

FIG. 20 shows a swiping state machine for the block puzzle game.

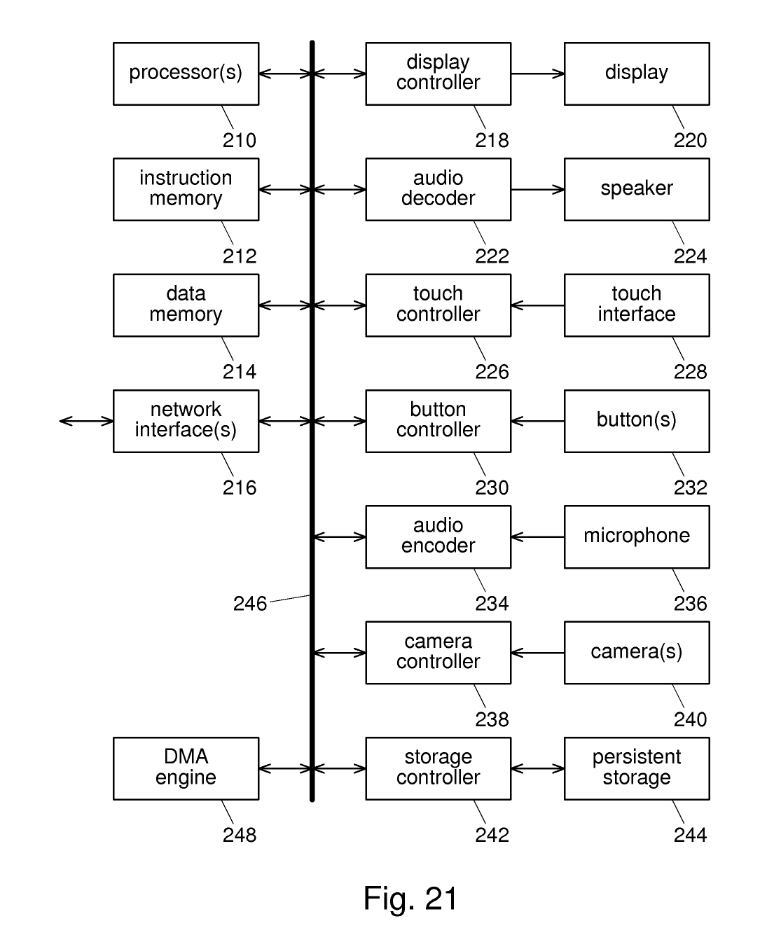

FIG. 21 shows a device block diagram for the block puzzle game machine.

### DRAWINGS

### Reference Numerals

100 Block puzzle.
102 Puzzle block.
104 Front pattern of puzzle block.
106 Back pattern of puzzle block.
108 Concave interlock feature.
110 Convex interlock feature.
112 Exterior pattern of puzzle block.
114 Interior pattern of puzzle block.
120 Block puzzle game machine.
122 Touchscreen.
130 Home button.
132 Undo button.
134 Redo button.
136 Scramble button.
138 Reset button.
140 Info button.
142 Pause button.
144 Settings button.
146 Move count indicator.
148 Elapsed time indicator.
150 Block puzzle game.
152 Game state datastore.
154 Update animation activity.
156 Draw puzzle activity.
158 Accept touch event activity.
160 Interpret touch event activity.
170 Game state.
172 Session history.
174 Session record.
176 Puzzle state.
178 Puzzle block state.
180 Touch state.
182 Animation state.
184 Rotation state.
190 Session state machine.
192 Stopped state.
194 Running state.
196 Paused state.
200 Swiping state machine.
202 Up state.
204 Down state.
206 Swiping state.
210 Processor(s).
212 Instruction memory.
214 Data memory.
216 Network interface(s).
218 Display controller.
220 Display.
222 Audio decoder.
224 Speaker.
226 Touch controller.
228 Touch interface.
230 Button controller.
232 Button(s).
234 Audio encoder.
236 Microphone.
238 Camera controller.
240 Camera(s).
242 Storage controller.
244 Persistent storage.
246 Address and data bus.
248 DMA engine.

### DETAILED DESCRIPTION OF PREFERRED EMBODIMENTS

### 2×2 Block Puzzle

FIG. 1 shows a perspective view of a 2×2 block puzzle 100. The block puzzle 100 consists of four identical cubic blocks 102, arranged in a 2×2 array.

FIG. 2A shows a view of the top and front of one puzzle block 102, while FIG. 2B shows a view of the bottom and back of the puzzle block 102.

The top and front faces of the puzzle block 102 each bears a pattern that is a different fragment of a ‘front’ pattern 104, while the bottom and back faces each bears a pattern that is a different fragment of a ‘back’ pattern 106. The front pattern 104 and the back pattern 106 are rendered so that they may be easily distinguished. For example, they may be rendered using different colors or textures. The two patterns are also rendered so that they contrast with the unpatterned areas of each face.

FIG. 3 shows the surface of the puzzle block 102 unfolded, and illustrates how each fragment of the front pattern 104 (and back pattern 106) forms a smooth connection with its neighboring fragment. FIG. 3 also illustrates that the back pattern 106 is a mirror image of the front pattern 104.

Each face pattern corresponds to a unique fragment of the front pattern 104 or back pattern 106, and the number of possible configurations of the puzzle is thereby maximised. Each fragment is also rotationally asymmetric and designed to be suggestive of its neighboring fragment, so that a block does not need to be rotated or viewed from the side to infer what fragment is on which of the faces adjoining its visible face.

The puzzle block 102 may be constructed from any suitable material, or mixture of materials, including wood, polymer, ceramic, glass, metal, textile, etc. It may be manufactured in any suitable way, including by hand-shaping, milling, injection molding, fused deposition, sintering, stereolithography, casting, etc.

The patterned faces of the puzzle block 102 may be rendered in any suitable way, including via a surface finish such as painting or dyeing, via an inlayed material, via sunken relief, via surface texture, or via a combination of these. Sunken relief may be stamped or embossed, or formed into the surface during manufacturing (e.g. during injection molding).

### Scrambling and Solving the 2×2 Block Puzzle

FIG. 4 shows a plan view of the 2×2 puzzle 100 in its solved state. In this state the four upwards-facing pattern fragments of the four blocks 102 join to form a larger cyclic pattern, i.e. the solution pattern.

Only two kinds of moves are allowed when scrambling or solving the puzzle 100: a row of blocks 102 may be rotated 90 degrees about the longitudinal (x) axis of the row, and a column of blocks 102 may be rotated 90 degrees about the longitudinal (y) axis of the column. A rotation may be clockwise or anticlockwise.

Rotating by an integer multiple N of 90 degrees is allowed, but counts as N moves.

Rotating a block 102 individually is not allowed, nor is changing its position in the puzzle 100.

The puzzle 100 is scrambled by first arranging it in the solved configuration, and then applying a succession of arbitrary moves. Alternatively the puzzle 100 may be scrambled by arranging it in a known valid scrambled configuration, e.g. with reference to a list of such configurations.

The puzzle 100 is solved by applying a succession of moves until it is once again in the solved configuration.

Constraining the allowed moves to row and column rotations makes the puzzle 100 challenging to solve and thereby provides an engaging experience.

### Move Notation

As shown in FIG. 4, each of the eight possible moves can be labelled according to the index of the row or column it applies to and its rotation direction. Rows are numbered from bottom to top, starting at zero. Columns are numbered from left to right, starting at zero. With reference to a right-handed x-y coordinate system, a clockwise row rotation about the row's x axis is labelled with a ‘U’ (up), and an anticlockwise row rotation with a ‘D’ (down). Similarly, a clockwise column rotation about the column's y axis is labelled with ‘L’ (left), and an anticlockwise column rotation with an ‘R” (right).

Thus the full set of eight possible moves is {0U,0D,1U,1D,0L,0R,1L,1R}.

### Example Moves

FIG. 5A shows the 2×2 puzzle 100 after being lightly scrambled (using just two moves: 1R followed by 1D).

FIGS. 5B and 5C show the puzzle 100 being solved. FIG. 5B shows the puzzle during the first move, a 1U row rotation move. FIG. 5C shows the puzzle 100 during the second and final move, a 1L column rotation move.

Thus solution move sequence is (1U,1L), the inverse of the scramble move sequence (1R,1D).

### Manual Execution of Moves

As illustrated in FIG. 5B, a row rotation move may be executed manually by pressing on each end of the row of blocks 102 with the fingers of two hands, and then lifting, rotating and replacing the row. By pressing with the tips of two fingers of each hand (e.g. the index finger and the middle finger), the row of blocks is easily rotated 90 degrees in either direction by moving the fingertips relative to each other.

As illustrated in FIG. 5C, a column rotation move may be executed manually in analogous fashion, again ideally using the tips of two fingers of each hand.

### Configuration Space of 2×2 Block Puzzle

Each block 102 has twenty-four possible configurations in the puzzle 100, corresponding to any one of the block's six faces facing upwards, in any of four orientations.

The 2×2 puzzle therefore has 331,776 possible configurations (i.e. 24⁴).

However, due to parity restrictions imposed by the constrained set of moves, only half of the possible configurations are reachable from the solved state. The 2×2 puzzle therefore has 165,888 valid configurations.

Since only half of the possible configurations of the 2×2 puzzle 100 are solvable, the puzzle 100 cannot be scrambled by arranging it in an arbitrary configuration, i.e. the puzzle blocks cannot be rolled like dice and then assembled into the puzzle.

### Solutions to 2×2 Block Puzzle

The inverse of the scramble move sequence is always a valid solution move sequence, but one or more shorter solution move sequences may exist for a given scrambled configuration.

The optimal solution move sequence for a given configuration is the shortest possible move sequence. A solution move sequence is hereafter referred to simply as a solution, and the number of moves as the solution length.

The largest optimal solution length for the 2×2 puzzle 100 is 12. The mean length of all optimal solutions for the 2×2 puzzle 100 is 7.8, and the median is 8.

### Solving the 2×2 Block Puzzle Manually

A practical but not necessarily optimal method for solving the 2×2 block puzzle 100 manually consists of two phases. In the first phase the puzzle is manipulated so that all of the fragments of the solution pattern face up. In the second phase the puzzle is manipulated so that all of the fragments of the solution pattern are correctly oriented to form the solution pattern.

In the first phase, if a particular block is facing down, then it can be made to face up by rotating either its row or column twice. If it is facing to the side then it can be made to face up by rotating either its row or column as appropriate.

In the first phase, when facing a particular block, it is advantageous to not disturb the facing of other blocks that have already been faced. If facing a particular block involves one or more column rotations, then a pair of row rotation can be used to save and subsequently restore the facing of the other block in the column. Similarly, if facing a particular block involves one or more row rotations, then a pair of column rotations can be used to save and subsequently restore the facing of the other block in the row. For example, if the block at (0,0) is facing to the left then a column rotation of OR is required to face it, and the facing of the block at (1,0) can be saved and restored using a pair of row rotations 1U and 1D. The full sequence then becomes (1U,0R,1D).

At the start of the second phase all of the blocks are correctly faced, but any number of blocks may be incorrectly oriented. The following notation is used to refer to a configuration of this kind: [[r(0,0),r(0,1)],[r(1,0),r(1,1)]], where each element r(row,column) represents the (z) rotation of that element relative to its correct rotation. Thus [[0,0],[0,0]] represents the solution configuration.

If a single block is incorrectly oriented then the configuration is of the form [[2,0],[0,0]] (with obvious variations), and the solution is the move sequence (0L,0U,0L,0L,0D,0L) (with corresponding variations).

If a pair of adjacent blocks are incorrectly oriented then the configuration is of the form [[1,1],[0,0]], [[1,3],[0,0]] or [[2,2],[0,0]] (all with obvious variations). The solution to the first form is the move sequence (1L,0L,0D,1R,0R), the solution to the second form is the move sequence (1L,0R,0U,1R,0L), and the solution to the third form is (1L,0L,0U,0U,1R,0R) (all with corresponding variations).

If a pair of diagonally opposite blocks are incorrectly oriented then the configuration is of the form [[1,0],[0,1]], [[1,0],[0,3]] or [[2,0],[0,2]] (with obvious variations). The solution to the first form is the move sequence (1L,0L,1D,1R,0R,1U,0D,0R,1D,0U), the solution to the second form is (1L,0L,1U,1R,0R,1U,0U,0L,1D,0D), and the solution to the third form is (1L,0L,1U,1L,0U,1L,1D,1L,0U,0R) (all with corresponding variations).

If three blocks are incorrectly oriented then the configuration is of the form [[1,1],[0,2]], [[1,2],[0,1]] or [[2,2],[0,2]] (with obvious variations). The solution to the first form is the move sequence (1L,0L,0L,1U,0R,0D,0R,1U,1R), the solution to the second form is (1L,0L,1U,1L,0L,1U,0U,0L,1U,0U), and the solution to the third form is (0L,1U,1L,1L,1D,0U,0U,0R) (all with corresponding variations).

If four blocks are incorrectly oriented then the configuration is of the form [[1,1],[1,1]], [[2,2],[2,2], [[1,1],[2,2]], [[1,2],[1,2]], and [1,2],[2,1] (with obvious variations). The solution to the first form is the move sequence (1L,0L,1D,0D,1R,0R), the solution to the second form is (1L,1L,0L,0L,1U,1U,0U,0U), the solution to the third form is (1L,0L,1U,1U,0D,1R,0R), the solution to the fourth form is (1U,0U,1L,1L,0L,1D,0D), and the solution to the fifth form is (1L,0L,1U,1L,0L,1U,0D,0R,1U,0D) (all with corresponding variations).

If four blocks are incorrectly oriented then this can also be treated as two separate two-block problems.

If three blocks are incorrectly oriented then this can also be treated as a one-block problem and a two-block problem.

If two blocks are incorrectly oriented then this can also be treated as two separate one-block problems if the orientations are even rather than odd.

### Anti-Slip Features

When a pair of puzzle blocks 102 is lifted as part of a row or column rotation move there is a possibility of lateral slippage between their contacting faces, and this may result in the blocks being dropped and the state of the puzzle being lost. To prevent this, each puzzle block 102 may incorporate one or more anti-slip features. This can include constructing each puzzle block 102 out of a high-friction material; finishing the surface of the puzzle block with a rough texture; coating the puzzle block with a high-friction surface finish (such as an elastomer); and incorporating interlock features on or in the surface of the puzzle block.

Anti-slip features are particularly useful when puzzle blocks 102 are lifted in groups of more than two, such as is required by larger block puzzles 100, as discussed further below.

FIG. 6 shows the puzzle block 102 enhanced with interlock features. Each face of the block 102 bears four pairs of interlock features, each pair consisting of a concave interlock feature 108 and a convex interlock feature 110.

When the faces of two blocks 102 are brought together, each concave interlock feature 108 on the face of the first block 102 mates with a matching convex interlock feature 110 on the face of the second block 102, and vice versa. This prevents lateral slippage between the faces of the two blocks.

The interlock features are arranged according to the four-fold rotational symmetry of the face so that they mate correctly irrespective of the relative 90-degree rotation of two facing blocks.

FIG. 7A shows a plan view of the block 102 with interlock features, while FIG. 7B shows a cross-section of the block 102 and its interlock features.

### Easier 2×2 Block Puzzle

FIG. 8 shows a perspective view of an easier 2×2 block puzzle 100, consisting of a 2×2 array of easier puzzle blocks 102.

FIG. 9A shows a view of the top and front of one easier puzzle block 102, while FIG. 9B shows a view of the bottom and back of the easier puzzle block 102.

FIG. 10 shows the surface of the easier puzzle block 102 unfolded.

FIG. 11 shows a plan view of the easier 2×2 puzzle 100 in its solved state.

Compared with the harder block puzzle 100 shown in FIG. 4, the easier block puzzle 100 shown in FIG. 11 is easier to solve because the top-facing bullseye pattern on each of its puzzle blocks in the solved state is rotationally symmetric, hence the easier puzzle has 256 (4⁴) equivalent solved configurations corresponding to the one solved configuration of the harder puzzle.

The triangle pattern on each of the side faces is asymmetric in order to assist with identifying the move required to reveal the bullseye face. The square pattern on the bottom face is rotationally symmetric in order to indicate that any move is equivalent.

If the face patterns of the easier puzzle block 102 are all made symmetric, e.g. each face pattern is simply rendered with a different solid color, then the resultant block puzzle 100 becomes slightly more difficult to solve than the block puzzle shown in FIG. 11, but still easier than the harder block puzzle shown in FIG. 4.

Note that the term ‘face pattern’, as used here, includes any kind of solid coloring or texturing of a face, even in the absence of any other distinguishing features.

Block Puzzle Variants with Different Sizes

FIG. 12A, FIG. 12B, FIG. 12C, FIG. 12D and FIG. 12E show plan views of 2×1, 3×2, 3×3, 4×3 and 4×4 block puzzles respectively, all utilising the harder puzzle block 102 shown in FIG. 2A and FIG. 2B.

Each puzzle is shown in its solved state, and each solved state utilises the interconnecting nature of the pattern fragments to produce an aesthetically pleasing overall solution pattern.

The solution patterns shown for the 2×2, 3×2, 4×3 and 4×4 block puzzles all share a structure of concentric cycles, whereas the solution pattern shown for the 3×3 block puzzle has a serpentine structure. The serpentine structure of the 3×3 block puzzle may also be used for other puzzle sizes, i.e. in place of the cyclic structure.

Both the cyclic and serpentine solution pattern structures can be scaled to any puzzle size.

Each puzzle is scrambled and solved using only row and column rotation moves, as per the 2×2 puzzle described above.

The number of possible configurations for an M×N puzzle is 24^{MN}, i.e. 576 for the 2×1 puzzle, 331,776 for the 2×2 puzzle, 1.9×10⁸ for the 3×2 puzzle, 2.6×10¹² for the 3×3 puzzle, and so on. However, as previously noted, the number of valid (i.e. solvable) configurations is smaller due to parity restrictions imposed by the constrained set of moves. For an M×N puzzle the number of distinct parity-induced configuration subsets is 2^{(MN-(M+N-1))}, i.e. it is 1 for the 2×1 puzzle, 2 for the 2×2 puzzle, 4 for the 3×2 puzzle, 16 for the 3×3 puzzle, and so on. The number of valid solutions is therefore 165,888 for the 2×2 puzzle, 4.7×10⁷ for the 3×2 puzzle, and 1.7×10¹¹ for the 3×3 puzzle.

Even a single puzzle block 102 constitutes a meaningful block puzzle when it is only allowed to be solved using row and column rotation moves, and requires up to four moves to solve.

### Puzzle Block Size and Shape

The puzzle block 102 may be any suitable size, but is preferably sized to allow comfortable manual manipulation when it is part of a row or column of the puzzle 100. For example, it may be in the range of 2-10 cm. It may also be substantially larger, such as when in the form of a children's soft block toy. For example, it may then be in the range 10-100 cm.

The puzzle block 102 is preferably substantially cubic, i.e. it has six distinct faces and has the same size in each dimension. Although cubic, the puzzle block may have substantially rounded corners and edges without detracting from its function.

### Pictorial Block Puzzle

The solution patterns shown in FIG. 4, FIG. 11, and FIG. 12A through FIG. 12E are somewhat abstract. However, it is also possible to utilise solution patterns that are more pictorial, including drawings, paintings, and other artwork; monochrome and color photographs; and computer renderings from two-dimensional and three-dimensional models.

A picture with a 2×3 or 3×2 aspect ratio (either intrinsically or after cropping) can be broken up into six different square fragments, and each fragment can then be used as the pattern for a different face of a puzzle block 102. Six identical such puzzle blocks 102 can then be assembled into a 2×3 or 3×2 puzzle 100, utilising the original picture as the solution pattern.

Rather than utilising a single picture and identical puzzle blocks 102, a block puzzle 100 can instead utilise six pictures, with each unique puzzle block 102 bearing a fragment of each of the six pictures on each of its six faces. Each unique puzzle block 102 must then be placed in its correct position within the array of the block puzzle 100. Any, several or all of the pictures can be designated as valid solution patterns. In a challenge mode, the aim can be to solve the puzzle 100 to show a particular picture. If six pictures are utilised then the size of the array of puzzle blocks is no longer constrained, and the aspect ratio of the array can be matched to the aspect ratio of the pictures, or vice versa.

In general, if there are U unique puzzle blocks 102 and N puzzle blocks in the puzzle 100, then the puzzle can represent P=6U/N different pictures. This assumes that the content of each picture is arbitrary, i.e. no face-sized fragment is repeated within a picture.

By way of example, if U=1 then P=6/N, e.g. if N=6 then P=1. This is the first case described above. If U=N then P=6, independent of the value of N. This is the second case described above. If U=2 and N=4 then P=3. And so on.

### Higher Puzzle Dimensionality

The block puzzle 100 described so far is one puzzle block deep, i.e. it is essentially two-dimensional. However, it is readily extended to three dimensions by adding one or more layers of puzzle blocks 102, e.g. extending it to 2×2×2, 3×3×3 or 4×4×4 puzzle blocks, and solving each face of the overall block puzzle cube (or parallelepiped, in general).

FIG. 13 shows a perspective view of a three-dimensional block puzzle 100. The block puzzle 100 consists of eight identical cubic blocks 102, arranged in a 2×2×2 array.

FIG. 14A shows a view of the top and front of one puzzle block 102, while FIG. 14B shows a view of the bottom and back of the puzzle block 102.

The patterning of the puzzle block 102 shown in FIG. 14A and FIG. 14B differs from that of the puzzle block shown in FIG. 2A and FIG. 2B. Each face of the puzzle block 102 that is part of an exterior face of the block puzzle 100 in its solved state, as shown in FIG. 13, bears an ‘exterior’ pattern 112, while each face of the puzzle block 102 that is part of an interior face in the solved state bears an ‘interior’ pattern 114. The exterior pattern 112 and the interior pattern 114 are rendered so that they may be easily distinguished. For example, they may be rendered using different colors or textures.

The exterior pattern 112 may be the rendered in the same way on each face, or in a different way to allow the different exterior faces of the puzzle block 102 to be distinguished (e.g. by color or texture). Likewise, the interior pattern 114 may be the rendered in the same way or in a different way on each face.

Although the exterior face pattern 112 and interior face pattern 114 shown in FIG. 14A and FIG. 14B differ and are rotationally asymmetric, in another variation they are rotationally symmetric and differ only by color or texture. For example, each of the six faces of the puzzle block 102 may simply bear a different color, and the correct orientation of each puzzle block in the solved state is enforced by the required color of each face of the overall puzzle in the solved state.

When the size of the block puzzle 100 is 2×2×2, each puzzle block 102 is a corner block and the exterior pattern 112 produces an aesthetic solution pattern on each face of the puzzle. When the size of the block puzzle exceeds 2×2×2, additional puzzle blocks 102 with different face patterns are used in non-corner positions, for example utilising the linking face pattern shown on the left face of the puzzle block in FIG. 2A. Puzzle blocks interior to a face of the puzzle can utilise corner or linking face patterns as appropriate. If the six faces of the puzzle block 102 simply bear different colors, then a single puzzle block is suitable for all positions in the puzzle. However, if each face of the puzzle has a central block (i.e. the size of the puzzle is odd in all dimensions), then it can be useful to indicate the required color of the face by rendering the central block of each face with the same face-specific color on each of its faces.

The puzzle blocks 102 can also be patterned pictorially, as described above. In particular, when six pictures are used to pattern a set of unique puzzle blocks, each of the six pictures can be shown on a different face of the block puzzle in its solved state.

When the block puzzle 100 is more than one puzzle block deep, i.e. it is three-dimensional, the entire puzzle needs to be rotated to allow manipulation of rows and columns on its other faces. A three-dimensional block puzzle 100 is therefore somewhat more amenable to virtual rather than physical manipulation, as discussed below. However, the use of anti-slip features on the puzzle blocks 102, as discussed above, can aid physical manipulation of the block puzzle 100 as a whole.

### Block Puzzle Video Game

It is advantageous to implement the block puzzle 100 as a video game because it allows a number of aspects of interacting with the block puzzle to be automated, including effective scrambling, preventing invalid moves, undo/redo, score-keeping and time-keeping. In addition, it allows different modes of game-play to be provided, including challenge modes where the user has to complete levels of increasing difficulty (e.g. increasing puzzle size and dimensionality), and multi-user modes such as head-to-head contests. It also more easily supports manipulation of puzzles or greater size or dimensionality.

The block puzzle video game can be implemented as a software application executing on a general-purpose computing device such as a personal computer, a tablet, or a smartphone. The computing device may be running a general-purpose or mobile operating system such as Microsoft Windows, Apple Mac OS X, Apple iOS, or Google Android. Alternatively the block puzzle video game may be implemented as a software application for a more specialised game machine such as a game console or handheld game machine, such as a Microsoft Xbox, Sony PlayStation (or PlayStation Portable), or Nintendo Wii.

Alternatively still, the block puzzle video game may be implemented using a machine dedicated to the block puzzle 100.

The game machine is preferably a general-purpose portable handheld device with a touchscreen, such as an Apple iPod Touch or iPhone [Ording10]. A general-purpose portable handheld device allows convenient casual access to the puzzle game, and a touchscreen allows particularly intuitive manipulation of the virtual on-screen block puzzle 100.

As an alternative to a touchscreen, a mouse, joystick or other pointing device may be used to interact with virtual on-screen buttons and the virtual on-screen block puzzle 100. Alternatively or additionally, various game functions, such as row and column rotations, may be provided via dedicated hardware buttons and/or via keyboard mappings. Alternatively still, various game functions may be controlled via gaze and gestures tracked via a camera, or via voice commands.

FIG. 15A shows the block puzzle 100 provided as a video game via a touchscreen game machine 120.

FIG. 15A shows the entire user interface of the block puzzle game provided via the touchscreen 122, including virtual buttons, indicators, and the virtual block puzzle itself.

The block puzzle game user interface provides the following function buttons: home 130—returns the game to a home screen where different game modes may be chosen; undo 132 —undoes the last move, if any, and decrements the move count; redo 134 —redoes the last undone move, if any, and increments the move count; scramble 136 —scrambles the block puzzle and sets the move count and the elapsed time to zero; reset 138 —stops the game session and resets the puzzle to the solved state; info 140 —shows a screen with information about the game, including hyperlinks to related information; pause 142 —pauses the game session (including the elapsed time) and shows a paused screen which hides the puzzle; and settings 144 —shows a settings screen where various settings may be adjusted, such as puzzle size and audio preferences.

The block puzzle game user interface provides the following indicators: move count 146 —shows the move count since the last scramble; and elapsed time 148 —shows the elapsed time since the last scramble.

The block puzzle game user interface displays a top perspective view of the virtual block puzzle, and allows the user to execute every possible row and column rotation move by simply swiping on the corresponding row or column in the appropriate direction (i.e. left or right for column rotations, and up or down for row rotations). The game software distinguishes a row rotation from a column rotation from the swipe direction.

FIG. 15B shows the virtual on-screen block puzzle 100 during a column rotation move executed by the user swiping on the touchscreen 122 with a finger. The column of blocks on the left, which is not being rotated, has been automatically moved out of the way to make room for the column on the right while it is being rotated. In general, any row or column that is not being rotated is moved out of the way dynamically in proportion to the sine of the angle of rotation from the nearest multiple of 90 degrees.

FIG. 16A shows a virtual on-screen three-dimensional block puzzle 100, and FIG. 16B shows it during a column rotation move.

If the block puzzle 100 is three-dimensional then one-finger swipes are used to rotate individual rows and columns, and two-finger swipes are used to rotate the entire puzzle, i.e. for access to rows and columns on another face of the puzzle. Alternatively, one-finger swipes on the screen adjacent to rather than on the block puzzle can be used to rotate the entire puzzle.

Although FIG. 16A and FIG. 16B show the puzzle displayed with three of its faces visible, an alternative view, even for a three-dimensional puzzle, is the plan view of FIG. 15A and FIG. 15B. In that case the puzzle can be rotated between different plan views of its different faces.

### Block Puzzle Video Game Logic

FIG. 17 shows a high-level activity diagram for the block puzzle game 150. The activity diagram shows a display loop and an interaction loop executing in parallel, and communicating via a shared game state datastore 152.

The display loop is driven by a timer. Every time the timer fires the update animation activity 154 updates any active animation recorded in the game state datastore 152, and the subsequent draw puzzle activity 160 redraws the block puzzle to reflect the current animation and touch state. Since both animations and touch events affect the displayed block puzzle, touch events are disabled during animations.

The interaction loop is driven by touch events. Each touch event is received by the accept touch event activity 158, and then interpreted by the subsequent interpret touch event activity 160, which updates the touch state in the game state datastore 152.

FIG. 18 shows a class diagram for the game state 170 of the block puzzle game 150. The game state 170 is stored in the game state datastore 152.

The game state 170 records: a session state (stopped, running, or paused), described below in relation to FIG. 19; and a list of moves for the current session which is used to support undo and redo (and which contains redoable moves if the current move count is smaller than the length of the list).

The game state 170 has the following associated classes: a session history 172; a session record 174; a puzzle state 176; a touch state 180; an animation state 182; and a rotation state 184.

The session history 172 consists of a set of session records 174, indexed by start time. Each session record 174 records a puzzle game session, and records: the id of the user; the puzzle size; the scrambled configuration; the start time; the move count used to solve the puzzle; and the elapsed time used to solve the puzzle. The session history can be used to show a leaderboard and to compute game statistics. One session record 174 represents the current session, and so is directly associated with the game state 170.

The puzzle state 176 records: the puzzle size (number of rows, columns and layers); and the 3D rotation of the puzzle as a whole. It further consists of a set of puzzle block states 178, indexed by row, column and layer (i, j, k). Each puzzle block state 178 records the 3D rotation of the corresponding puzzle block.

The touch state 180 records: a swiping state (up, down, or swiping), described below in relation to FIG. 20; the start point of the swipe; the index of the block initially touched; the axis of the touched face of the block; and the axis of rotation. The block index identifies a unique block, and the face axis identifies a pair of possible rotation axes, i.e. the two axes perpendicular to the face axis. During swiping one of these possible axes is identified as the actual axis of rotation, and the block index and rotation axis then together identify the unique row or column being rotated. The vector between the latest touch point in a touch event and the start point defines the extent of the swipe. The component of this vector perpendicular to the axis of rotation defines the magnitude of the rotation (obtained from the dot product of the swipe vector and the projection of the 3D rotation axis into 2D screen space).

The animation state 182 records: whether a rotation move animation is in progress; the time of the animation relative to the start; the index of the block being rotated; the axis of rotation; and the start angle for the animation (between plus and minus 90 degrees).

The rotation state 184 records: the index of the block being rotated; the axis of rotation; and the instantaneous rotation angle. It is used by the draw puzzle activity 156 (shown in FIG. 17) to draw the puzzle, and is set by the update animation activity 154 based on the animation state 182, or by the interpret touch event activity 160 based on the touch state 180.

FIG. 19 shows a session state machine 190 maintained by the interpret touch event activity 160 (shown in FIG. 17). Initially the session state machine 190 is in the stopped state 192. If the user presses the scramble button 136 (shown in FIG. 15A) then the puzzle 100 is scrambled and the session state machine 190 transitions to the running state 194. If the user presses the reset button 138 then the puzzle 100 is reset to the solved state and the session state machine 190 reverts to the stopped state 192. If the user makes a move (i.e. a row or column rotation move, or presses the undo button 132 or redo button 134), but the puzzle remains unsolved, then the session state machine 190 remains in the running state 194. If the user makes a move that solves the puzzle then the session state machine 190 reverts to the stopped state 192. If the user presses the pause button 142, or the game is automatically paused due to an external event (such as an incoming phone call), then the session state machine 190 transitions to the paused state 196. If the user subsequently presses the resume button (on the paused screen) then the session state machine 190 reverts to the running state 194.

FIG. 20 shows a swiping state machine 200 maintained by the interpret touch event activity 160 to manage the user manipulating the displayed puzzle 100. Initially the swiping state machine 200 is in the up state 202. If the user touches the displayed puzzle 100 with their finger then the swiping state machine 200 transitions to the down state 204, and the block index and face axis of the touched block are recorded in the touch state 180, together with the start point of the swipe.

As the user moves their finger, but while the touch point remains close to the start point, no meaningful rotation axis can be inferred and the swiping state machine 200 remains in the down state 204. If the user lifts their finger then the swiping state machine 200 reverts to the up state 202.

Once the user moves their finger a threshold distance away from the start point, a rotation axis can be reliably inferred and the swiping state machine 200 transitions to the swiping state 206. During this transition the rotation axis is recorded in the touch state 180. In addition, the rotation state 184, used by the draw puzzle activity 156, is set to reflect the instantaneous rotation of the row or column being swiped, i.e. in proportion to the distance swiped. As the user continues to move their finger the swiping state machine 200 remains in the swiping state 206. The rotation state 184 continues to be set according to the latest distance swiped. When the user lifts their finger the swiping state machine 200 reverts to the up state 202, and the animation state 182 is configured with an animation to rotate the row or column that was being swiped to the nearest multiple of 90 degrees. This may cause the row or column to rotate back to its pre-swipe configuration, i.e. if the swipe resulted in a rotation of less than 45 degrees. The update animation activity 154 subsequently updates the rotation state 184 to reflect the instantaneous rotation of the row or column at each time step during the animation.

Rotating to the nearest multiple of 90 degrees provides an intuitive user interface, since it is consistent with physics. It also allows peeking using partial rotations without inadvertently making a move. Rotating without too much gearing between swipe extent and rotation angle is also intuitive, although higher gearing can provide greater responsiveness.

As an alternative to rotating to the nearest multiple of 90 degrees, a smaller threshold can be used to in favor of rotations to adjacent configurations. For example, if a threshold of 15 degrees is used then any swipe-driven rotation of 15 degrees or more results in a 90-degree rotation. However, this can result in inadvertent moves during peeking.

Alternatively or additionally, the velocity of the swipe can be taken into account to allow the user to cause a rotation via a sufficiently fast flick gesture, even if the swipe is quite short. This can then support both fast moves and slow peeking.

### Block Puzzle Video Game Machine

FIG. 21 shows a block diagram for the block puzzle game machine 120.

The game machine 120 incorporates one or more processing units 210 for executing instructions stored in an instruction memory 212 and operating on data in a data memory 214. The processing units 210 include one or more general-purpose processing units (CPUs), and may include one or more special-purpose processors such as graphics processing units (GPUs).

The block puzzle game 150 is preferably implemented as software in the form of a set of instructions executable by the processor(s) 210. Alternatively the game machine 120 may utilise dedicated logic to implement the block puzzle game 150.

The game machine 120 incorporates one or more network interfaces 216 for communicating with other devices and with network-based (including Internet-based) software and services. The network interface(s) 216 may support both wired and wireless networking, and may support personal-area (e.g. Bluetooth/IEEE 802.15), local-area (e.g. Ethernet/IEEE 802.3, Wi-Fi/IEEE 802.11), and wide-area networks (e.g. cellular voice and data), either directly or via intermediate devices such as routers and gateways.

The network interface(s) 216 may be used to store information related to the block puzzle game 150 on a network server, to exchange information with other players, and to support multi-user modes of play.

The game machine 120 incorporates a display controller 218 for controlling a display 220; an audio decoder 222 for decoding digital audio and converting it to analog signals for driving a speaker 224; a touch controller 226 for detecting and digitising signals from a touch interface 228; a button controller 230 for detecting and digitising signals from one or more buttons 232; an audio encoder 234 for digitising and encoding audio from a microphone 236; and a camera controller 238 for capturing images from one or more cameras 240.

The display 220 may be used to display the user interface of the block puzzle game 150, while the touch interface 228 may be used to capture user interactions with the block puzzle game 150. The button(s) 232 may also be used to capture user interactions with the block puzzle game 150, or may be used to capture user interactions with the game machine 120 as a whole.

The speaker 224 may be used to output music and sound effects from the block puzzle game 150.

The touch interface 228 is preferably co-located with or intrinsic to the display 220, i.e. the display 220 and touch interface 228 together implement the touchscreen 122. Alternatively the touch interface 228 may be provided separately from the display, e.g. in the form of a touchpad or digitizing tablet. It may utilise any suitable touch detection technology, including capacitive, resistive, acoustic, and optical touch technology.

The microphone 236 may be used to support voice communication between the user and other remote players during multi-user play, and for voice control of the puzzle game 150.

The camera(s) 240 may be used to support video communication between the user and other remote players during multi-user play, and for gaze or gesture control of the puzzle game 150.

The game machine 120 incorporates a storage controller 242 for controlling the reading and writing of data from and to one or more persistent storage devices 244. The persistent storage may utilise any suitable persistent storage technology, including non-volatile memory such as NOR or NAND flash, magnetic disc and optical disc.

The block puzzle game 150 software may be stored in the persistent storage 244 and copied into the instruction memory 212 and data memory 214 for execution by the processor(s) 210. Alternatively the instruction memory 212 may be persistent and may store the block puzzle game 150 software even when it is not being executed.

The various hardware components of the puzzle game machine 120 are attached to and communicate via a shared address and data bus 246. Data transfer over the bus 246 between any two components may be controlled directly by the components, or may be delegated to a DMA engine 248.

### CONCLUSION

Both the physical and virtual embodiments of the block puzzle 100 described above provide an engaging experience to puzzlers of all ages. While a number of enabling embodiments have been described in detail, they should not be construed as limiting the scope. Many variations are possible, including variations in puzzle size, puzzle dimensionality, puzzle block shape, face patterning, and puzzle game user interface. The scope of the invention should be determined not by the embodiments described, but by the appended claims.

### REFERENCES

The contents of the following publications, referred to within this specification, are herein incorporated by reference.
[Nichols72] L. D. Nichols, “Pattern forming puzzle and method with pieces rotatable in groups”, U.S. Pat. No. 3,655,201, Apr. 11, 1972
[Ording10] B. Ording et al, “Portable electronic device with multi-touch input”, U.S. Pat. No. 7,812,826, Oct. 12, 2010
[Rom05] D. Rom, “Puzzle”, U.S. Pat. No. 6,883,802, Apr. 26, 2005
[Rubik83] E. Rubik, “Spatial logical toy”, U.S. Pat. No. 4,378,116, Mar. 29, 1983
[Seidman85] A. Seidman, “Puzzle toy”, U.S. Pat. No. 4,548,411, Oct. 22, 1985

1. A block puzzle game machine comprising:
(i) at least one processor,
(ii) at least one memory containing a program,
(iii) at least one display, and
(iv) at least one input mechanism,
the program comprising instructions executable by the at least one processor that implement a block puzzle game, the game comprising a virtual block puzzle, the block puzzle comprising an array of substantially cubic puzzle blocks, one face of each puzzle block bearing a face pattern that is a fragment of a solution pattern, the face patterns of the puzzle blocks together forming the solution pattern when the puzzle is in a solved state, the puzzle manipulable via a constrained set of moves to transform it from any one of a set of scrambled states to the solved state, the constrained set of moves comprising any move that rotates one row of puzzle blocks in the array ninety degrees about a longitudinal axis of the row, and any move that rotates one column of puzzle blocks in the array ninety degrees about a longitudinal axis of the column, the game configured to:
(a) display a representation of the puzzle on the at least one display,
(b) accept user input via the at least one input mechanism,
(c) identify, from the user input, one move from the constrained set of moves,
(d) transform the puzzle in accordance with the identified move, and
(e) display the transformed puzzle on the at least one display.

2. The game machine of claim 1, wherein the puzzle blocks are identical.

3. The block puzzle of claim 2, wherein each face of the identical puzzle block bears a different face pattern.

4. The block puzzle of claim 1, wherein the solution pattern fragments are identical.

5. The game machine of claim 1, wherein each solution pattern fragment has a different orientation in the solution pattern.

6. The game machine of claim 1, wherein each solution pattern fragment is different.

7. The game machine of claim 1, wherein each solution pattern fragment is rotationally asymmetric.

8. The game machine of claim 1, wherein each face of each puzzle block bears a different face pattern.

9. The game machine of claim 8, wherein the block puzzle has multiple solved states, each solved state having a different solution pattern formed from a different set of the face patterns of the puzzle blocks.

10. The game machine of claim 1, wherein the size of the array of puzzle blocks is selected from the group comprising: 2×1, 2×2, 3×2, 3×3, 4×3, 4×4, and 2×2×2.

11. The game machine of claim 1, wherein the solution pattern represents a picture selected from the group comprising: an abstract pattern, a drawing, a painting, an artwork, a photograph, and a computer rendering.

12. The game machine of claim 1, wherein the at least one input mechanism is selected from the group comprising: a touch interface, a digitizing interface, a button, a joystick, a mouse, a keyboard, gaze tracking, gesture recognition, and voice command recognition.

13. The game machine of claim 1, comprising a computing device selected from the group comprising: a personal computer, a tablet, a smartphone, a game console, and a handheld game machine.
